(19) United States
(12) Patent Application Publication
(10) Pub. No.: US 2013/0282761 A1
(43) Pub. Date: Oct. 24, 2013

(54) SYSTEM AND METHOD FOR ENTITY SHAPE ABSTRACTION IN AN ON DEMAND ENVIRONMENT

(71) Applicant: SALESFORCE.COM, INC., San Francisco, CA (US)

(72) Inventors: Steven Tamm, San Francisco, CA (US); Nathan Horne, Walnut Creek, CA (US); Frank Lopez, San Francisco, CA (US)

(21) Appl. No.: 13/865,943

(22) Filed: Apr. 18, 2013

Related U.S. Application Data
(60) Provisional application No. 61/625,750, filed on Apr. 18, 2012.
(60) Provisional application No. 61/801,844, filed on Mar. 15, 2013.

(51) Int. Cl. G06F 17/30

(52) U.S. Cl. CPC G06F 17/30283
USPC 707/781

(57) ABSTRACT

The technology disclosed relates to presenting a data entity interface that connects a multi-tenant database code to a multi-tenant database and at least one other database from a different data source. In particular, it relates to providing a custom entity shape that serves as a common interface from a multi-tenant database application code to multiple databases from one or more different data sources that have fields implementing at least some common data with different data structures. This common interface creates a layer of abstraction that provides a consistent behavior across the multiple databases and sets rules that govern how information is presented and shared with the different data sources.

### RELATED APPLICATION

This application claims the benefit of U.S. Provisional Patent Application No. 61/625,750, entitled, “System And Method For Entity Shape Abstraction In An On Demand Environment,” filed on 18 Apr. 2012 and U.S. Provisional Patent Application No. 61/801,844, entitled, “System and Method for Entity Shape Abstraction In An On Demand Environment,” filed on 15 Mar. 2013. These provisional applications are hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to presenting a data entity interface that connects a multi-tenant database code to a multi-tenant database and at least one other database from a different data source. In particular, it relates to providing a custom entity shape that serves as a common interface from a multi-tenant database application code to multiple databases from one or more different data sources that have fields implementing at least some common data with different data structures. This common interface creates a layer of abstraction that provides a consistent behavior across the multiple databases and sets rules that govern how information is presented and shared with the one or more different data sources. In one embodiment, the common interface may be a view across a single source with a filter.

In a multi-tenant database system, tenant organizations (i.e. tenants) use multi-tenant polymorphic applications such as Force.com that run on multi-tenant system databases. Tenants may run these applications on legacy databases instead of the multi-tenant system databases. For instance, a tenant may host Force.com on a SAP or Oracle database instead of the standard Salesforce.com (SFDC) database.

In some instances, tenants may desire to run their traditional enterprise software on multi-tenant system database rather than legacy databases. Multi-tenant applications may also allow each tenant to add custom extensions to standard data objects and/or create entirely new custom objects. Furthermore, customers of tenant organizations may wish to add their own custom data to the database system in addition to the standard entities and fields provided with standard applications.

In present multi-tenant environments (MTEs), switching from a legacy data source to a multi-tenant data source inevitably requires data migration, which is cumbersome, inefficient and highly error-prone. Moreover, customers of an MTE do not have unified access to all tenant-specific customizations in an MTE, which restricts them to perform operations and receive results that are tenant specific. This aspect opens up the possibility that changes to customizations in different tenant organizations could break integrations within the customers' databases. Therefore, the need for implementing effective methods that provide customers with cross-tenant operability through a common interface has become imperative.

Accordingly, it is desirable to provide systems and methods that successfully include all customizations implemented by tenants of an MTE in a common interface. An opportunity arises that: enables customers to access services and objects of an MTE in a platform-independent manner; enables customers to manipulate data globally through a common interface instead of conventional local object definitions; ensures that key integration points and business process automation logic are not broken by new customizations; and/or enables customers to map their applications to a common interface without requiring data migration or giving up existing customizations. Increased customer adoption, more effective customer interactions, and higher overall customer satisfaction and retention may result.

### SUMMARY

The technology disclosed relates to presenting a data entity interface that connects a multi-tenant database code to a multi-tenant database and at least one other database from a different data source. In particular, it relates to providing a custom entity shape that serves as a common interface from a multi-tenant database application code to multiple databases from different data sources that have fields implementing at least some common data with different data structures. This common interface creates a layer of abstraction that provides a consistent behavior across the multiple databases and sets rules that govern how information is presented and shared with the different data sources.

Other aspects and advantages of the present invention can be seen on review of the drawings, the detailed description and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows a block diagram of one implementation of a multi-tenant environment.

FIG. 2 illustrates a default implementation of an entity interface.

FIG. 3 illustrates a custom implementation of an entity shape.

FIG. 4 illustrates Salesforce Object Query Language (SOQL) query implementation of an entity shape.

FIG. 5 is a block diagram of one implementation of an entity shape model.

FIG. 6 illustrates one implementation of a user interface for creating an entity shape.

FIG. 7 is a block diagram of one implementation of a custom entity shape abstraction.

FIG. 8 is a block diagram of one implementation of a platform entity.

FIG. 9 is a message sequence chart of one implementation for integrating an application including multiple entity interfaces with a multi-tenant data source and another data source.

FIGS. 10A and 10B are high-level flow charts of an entity shape abstraction.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Entity shape is an abstract interface that interacts with multiple databases having different data structures. For example, in a multi-tenant environment like Salesforce.com, a standard object referred to as “Contract” represents a contract or business agreement associated with an account, whereas a custom object called “Service contract” represents a customer support contract or business agreement. Entity shape can provide users with unified access to both the above mentioned object types by presenting a common interface that abstracts the underlying field definitions of the different data structures and object types. In another example, entity shape can run a multi-tenant application like Force.com against a multi-tenant data source like Salesforce.com and legacy data sources like SAP or Oracle.

In some implementations, entity shape is a customizable abstract interface that automatically adopts user-selected workflow rules, approval processes, triggers and other methods to a user-selected database. A workflow rule automatically sets workflow actions into motion when its designated conditions are met. An approval process is an automated process that users can use to approve actions in an interface. A trigger is a programming language code that automatically executes before or after operations such as insert, update, delete, merge, upsert, undelete, etc. Apex triggers are stored as metadata in the application under the object with which they are associated.

In some implementations, entity shape can connect metadata objects and fields of the metadata objects via data abstractions to the multiple databases from different data sources. Different implementations of entity shape abstraction are described. These implementations have in common multi-tenant database code that is agnostic to whether it runs against multi-tenant data source or another data source. In each of these implementations, an entity shape is defined that is responsive to a user-selection or reselection of a multi-tenant data source and/or another data source and that further automatically maps objects and fields to the selected data source.

Entity shape can access a multi-tenant data source and another data source using a single query like Salesforce Object Query Language (SOQL) that aggregates data from the multi-tenant database and the other database. In some implementations, entity shape can execute an instead-of statement to switch to or from the multi-tenant data source and the other data source and vice-versa.

The technology disclosed relates to entity abstractions for use in a computer-implemented system. The described subject matter can be implemented in the context of any computer-implemented system, such as a software-based system, a database system, a multi-tenant environment, or the like. Moreover, the described subject matter can be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

### Multi-Tenant Environment

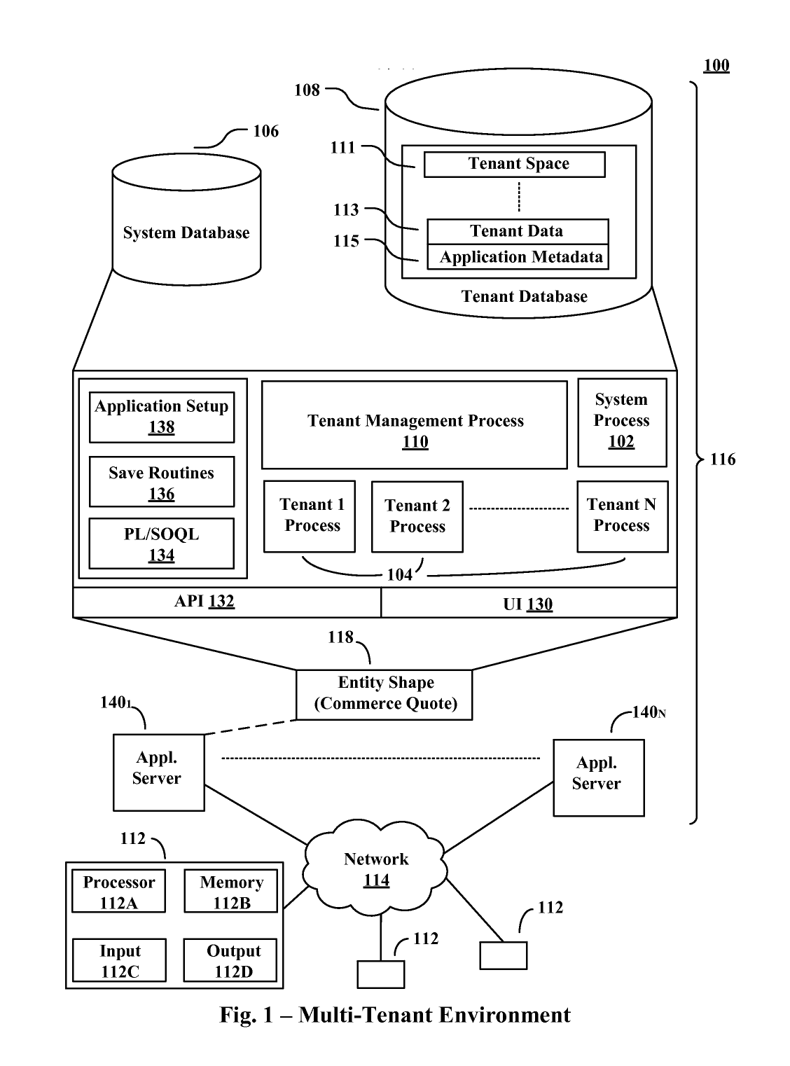

FIG. 1 shows a block diagram of one implementation of a multi-tenant environment 100. FIG. 1 also shows that user system 112 may include processor system 112A, memory system 112B, input system 112C, and output system 112D. FIG. 1 includes network 114, system database 106, and tenant database 108. FIG. 1 also shows tenant database 108 with tenant storage 111, user storage 113 and application metadata 115, user interface (UI) 130, application-programming interface (API) 132, PL/SOQL 134, save routines 136, application setup mechanism 138, applications servers 140₁-140_{N}, tenant management process space 110, system process space 102, and tenant process spaces 104. In other implementations, environment 100 may not have the same elements as those listed above and/or may have other/different elements instead of, or in addition to, those listed above.

Regarding user system 112, processor system 112A may be any combination of processors such as a digital signal processor (DSP), microprocessor, microcontroller, central procession unit (CPU) or graphics processing unit (GPU), application specific integrated circuit (ASIC), reduced instruction set computing (RISC) or field-programmable gate array (FPGA). Memory system 112B may be any combination of one or more memory devices, short term, long term memory, and/or volatile memory like Read Only Memory (ROM), Random Access Memory (RAM), flash memory and disk drive among others. Input system 112C may be any combination of input devices, such as keyboards, mice, trackballs, scanners, cameras, and/or interfaces to networks. Output system 112D may be any combination of output devices, such as monitors, printers, and/or interfaces to networks.

Each application server 140₁-140_{N} may be configured to tenant database 108 and system database 106 therein to serve requests of user systems 112. The tenant database 108 might be divided into individual tenant storage 111 and user storage 113, which can be either a physical arrangement and/or a logical arrangement of data. User storage 113 and application metadata 115 might be similarly allocated for each user. For example, a copy of a user's most recently used (MRU) items might be stored to user storage 113. Similarly, a copy of MRU items for an entire organization that is a tenant might be stored to tenant storage 111. A UI 130 provides a user interface and an API 132 provides an application programming interface to system 116 resident processes to users and/or developers at user systems 112. The tenant data and the system data may be stored in various databases, such as SAP or Oracle databases.

An application setup mechanism supports application developers' creation and management of applications, which may be saved as metadata into tenant data storage 113 by save routines 136 for execution by subscribers as tenant process spaces 104 managed by tenant management process 110. Invocations to such applications may be coded using PL/SQL 134 that provides a programming language style interface extension to API 132. Invocations to applications may be detected by system processes, which manage retrieving application metadata 115 for the subscriber making the invocation and executing the metadata as an application in a virtual machine.

Entity shape 118 is exposed through API 132 and UI 130. An entity shape can act as an abstraction layer encompassing all tenant-specific customizations. An entity shape 118 can be connected to one or more application servers 140. Each application server 140 may be communicably coupled to database systems, e.g., having access to system database 106 and tenant database 108, via a different network connection. For example, one application server 140₁ might be coupled via the network 114 (e.g., the Internet), another application server 140₂ might be coupled via a direct network link, and another application server 140_{N} might be coupled by yet a different network connection.

In some MTEs, tenants may be allowed to create and store custom objects, or they may be allowed to customize standard entities or objects, for example by creating custom fields for standard objects, including custom index fields. For example, all custom entity data rows are stored in a single multi-tenant physical table, which may contain multiple logical tables per organization. In some implementations, multiple “tables” for a single customer may actually be stored in one large table and/or in the same table as the data of other customers.

### Host-Based Entity Shape

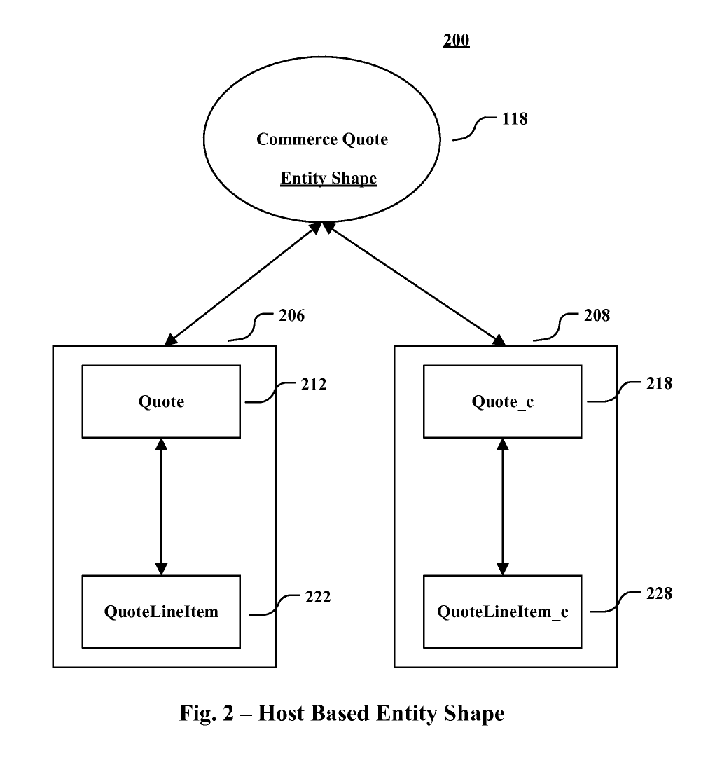

FIG. 2 illustrates a default implementation 200 of a data entity shape 118 referred to as “Commerce Quote.” Commerce Quote 118 serves as a common interface that can provide a plurality of implementations provided by a host of a multi-tenant environment like Salesforce.com including a standard implementation 206 standard objects such as Quote 212 and QuoteLineItem 222 and a custom implementation 208 with custom objects like Quote_c 218 and QuoteLineItem_c 228.

Commerce Quote 118 can provide schema definitions with objects, fields and attributes for both standard implementation 206 and custom implementation 208. At design-time, customers can select any implementation through a user interface (UI) 130 responsive to a user selection.

At run-time, commerce quote 118 can automatically map the metadata objects and fields of the selected implementation with the customer database. In some implementations, the metadata objects can aggregate data fields from the selected implementation to the customer database. In absence of any user selection, the standard implementation 206 can be automatically applied.

In some implementations, commerce quote 118 can select fields from the selected implementation that are common between the standard implementation 206 and custom implementation 208 and further query and assign methods to the selected fields in the selected implementation. In other implementations, processor system 112A can automatically adapt the connection of the selected fields in the selected implementation while connecting other fields in the metadata objects to the not selected implementation.

In some implementations, commerce quote 118 can support joins between the selected fields in the selected implementation and the fields in the not selected implementation without requiring specification of the implementation involved in a select-join statement. In other implementations, processor system 112A can automatically implement an instead-of statement to create an updatable view from a join across the standard implementation 206 and custom implementation 208. For example, the technology disclosed can use an instead-of statement to create an updatable view including quote 212 form the standard implementation 206 and quote_c 218 from the custom implementation 208 by querying directly to commerce quote 118 rather passing objects 212 and 218 and implementations 206 and 208 as parameters of a select-join statement.

In some implementations, commerce quote 118 can select fields that are not found in the not selected implementation and further query and assign methods to the selected fields in the selected implementation. In other implementations, processor system 112A can automatically adapt the connection of the selected fields in the selected implementation while connecting other fields in the metadata objects to the not selected implementation.

### Third-Party Based Entity Shape

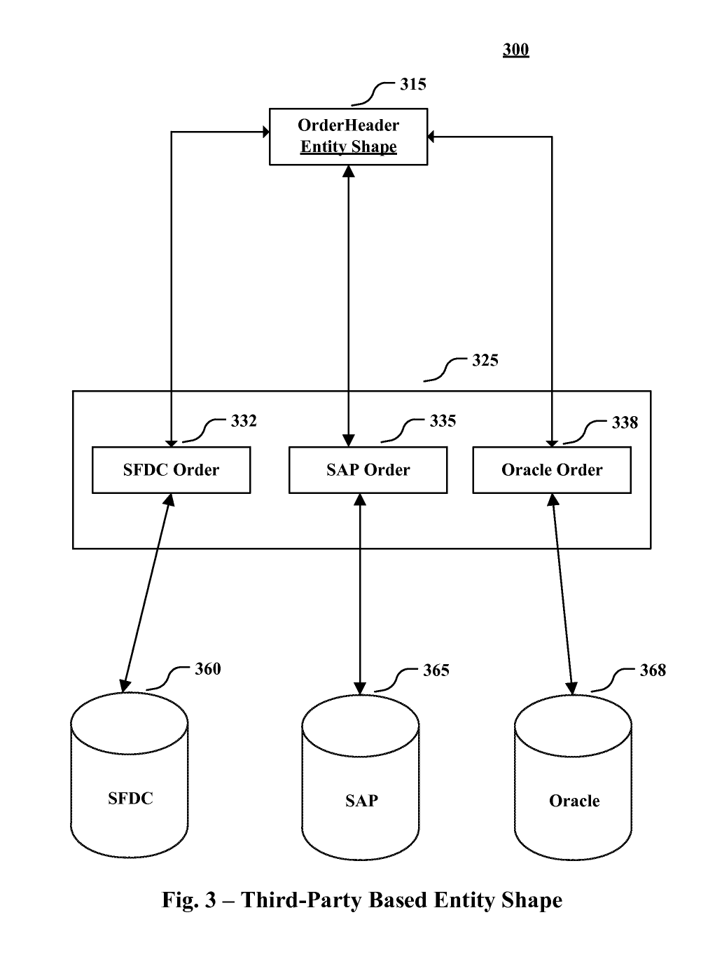

FIG. 3 illustrates a high-level block diagram of a process of implementing an entity shape created by third-party vendors for their customers according to one implementation. Here, a third-party implementation 300 of an entity shape 315 referred to as “OrderHeader” can provide a data entity interface 325 that can include custom objects such as SFDC order 332, SAP order 335 and Oracle order 338.

OrderHeader 335 can allow tenant organizations to provide a consistent run-time interface to their customers regardless of the customer database, thus abstracting away the location of the customer database. At design-time, customers can select the appropriate custom object through a user interface (UI) 130 responsive to a user selection. At run-time, rather than having customers to hard code to database schemas associated with a specific database, the data entity interface 335 can use SFDC order 332, SAP order 335 and Oracle order to automatically map to multiple tables in different data sources like SFDC 360, SAP 365 and Oracle 368 respectively.

In some implementations, the technology disclosed provides custom objects such as SFDC order 332, SAP order 335 and Oracle order 338 that include detailed field definitions of the same type as the respective data sources like SFDC 360, SAP 365 and Oracle 368. During run-time, the data entity interface 335 can identify the custom object selected by the customer at design-time and map its fields to the associated data source, without requiring to customers to provide the field definitions.

In some implementations, OrderHeader 335 can allow customers to assign workflow rules, approval processes and triggers at design-time that over-ride a data source selection. For example, a customer can write a workflow rule such that a user subscription to an application triggers a write operation on SFDC 360 and a group subscription to the application triggers a write operation on SAP 365. In other implementations, processor system 112A can apply the customer-selected workflow rules, approval processes and triggers to the appropriate database.

In some implementations, OrderHeader 335 can select fields from the selected custom object that are common between the custom object and not selected custom objects and further query and assign methods to the selected fields in the selected custom object. In other implementations, processor system 112A can automatically adapt the connection of the selected fields in the selected custom object while connecting other fields in the metadata objects to the not selected custom objects.

In some implementations, OrderHeader 335 can select fields from the selected custom object that are not found in the not selected custom objects and further query and assign methods to the selected fields in the selected custom object. In other implementations, processor system 112A can automatically adapt the connection of the selected fields in the selected custom object while connecting other fields in the metadata objects to the not selected custom objects.

### Query Implementation

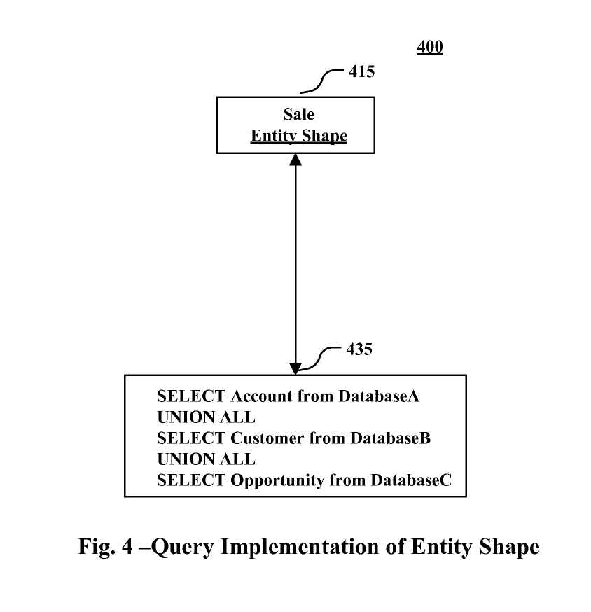

FIG. 4 illustrates Salesforce Object Query Language (SOQL) query implementation 400 of an entity shape 415 referred to as “Sale.” Sale 415 can include a SOQL query that makes calls to and from a plurality of databases like DatabaseA, DatabaseB and DatabaseC residing in different data sources such as SFDC 360, SAP 365 and Oracle 368 without requiring different implementations of FIG. 2 or different objects of FIG. 3.

Sale 415 can provide a data entity interface 435 that connects metadata objects and fields of the metadata objects via data abstractions to a multi-tenant data source such as SFDC 360 and one or more other data sources like SAP 365 and Oracle 368. In some implementations, the metadata objects can aggregate fields from multiple foreign metadata objects in either SAP 365 or Oracle 368. In other implementations, sale 415 can assign triggers and other methods such as workflow rules, approval processes etc. to the metadata objects and fields and automatically apply data access and assigned methods to SAP 365 and Oracle 368 at run-time through a SOQL query.

In some implementations, sale 415 can provide customers a unified access to different data sources by generating federated SOQL queries. These SOQL queries may be viewed by different data sources as a single request, but may in fact perform multiple operations in one or more databases. As shown in FIG. 4, a single SOQL query may be federated across DatabaseA, DatabaseB and DatabaseC to separately assemble an Account, a Customer and an Opportunity from the appropriate data source. In other implementations, sale 415 can use triggers, workflow rules and approval processes to implement an instead-of statement that creates an updatable view of the different databases.

### Entity Shape Model

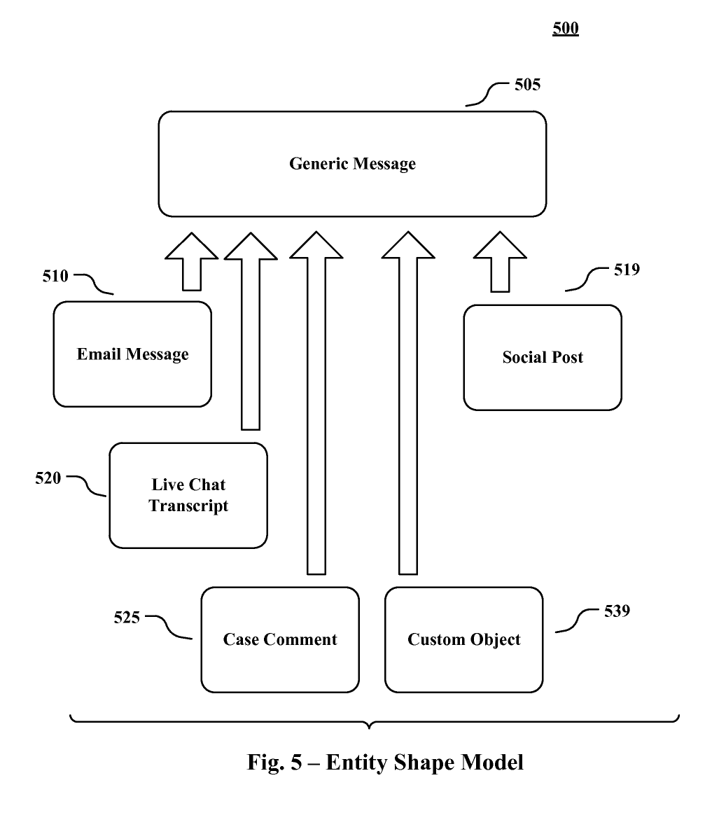

FIG. 5 is a block diagram of one implementation 500 of an entity shape model 505 referred to as “Generic Message.” Generic Message 505 defines message-centric functionality for an email message 510, live chat transcript 520, social post 519, case comment 525, custom object 539 and other message entities through a union query that returns records from one or more entities that implement Generic Message 505.

In some implementations, Generic Message 505 can define: necessary common fields to support business processes, workflow rules, approval processes and synthetic reporting capabilities for any type of inbound and outbound messages. For example, Generic Message 505 can define the information management frameworks for multi-media social applications like Chatter that provide social feeds from multiple social networking API's such as Twitter's Firehose and Facebook's Fire Graph API, e-mail clients like Yahoo and Gmail, and blog posts from blog aggregators like Blogger. Tenants that use Chatter for customer service can user Generic Message 505 to define methods that to handle Tweets, Facebook messages, emails, blog posts from customers in the same way rather than having to set up different workflow rules and processes for each media source.

In some implementations, Generic Message 505 can provide a generic message layer with message type and behavior modeling, starting with common fields, workflow rules and approval processes. Generic Message 505 can be an entity interface that gets its field values from the entity that implements it like an email message 510, thus allowing users to abstract common properties and business logic for any type of inbound and outbound messages.

### User Interface

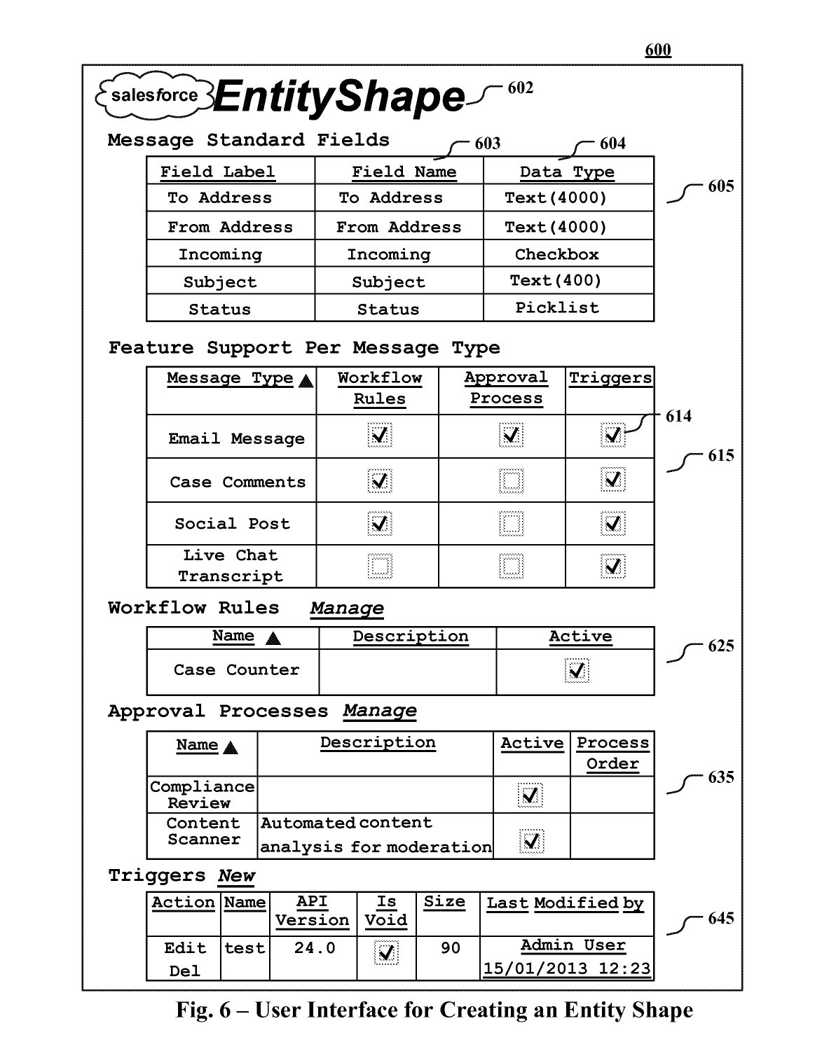

FIG. 6 illustrates one implementation 600 of a user interface 602 for creating an entity shape 118. As shown in FIG. 6, user interface 602 can include one or more methods such as message standard fields 605, feature support per message type 615, workflow rules 625, approval processes 635, and triggers 645. In other implementations, user interface 602 may not have the same methods as those listed above and/or may have other/different methods instead of, or in addition to, those listed above.

In some implementations, message standard fields 605 can specify the field labels and names such as “to address”, “from address”, “incoming”, “subject”, and “status.” It can also include the data type for each field label and name like text (400), checkbox, pick-list, etc. In other implementations, feature support per message type 615 can specify the message type: email message 510, live chat transcript 520, social post 519, and/or case comment 525 supported by entity shape 118.

In some implementations, workflow rules 625 can automate one or more actions based on an organization's processes such as: “tasks” to assign a new task to a user, role, or record owner; “email alerts” to send an email to one or more recipients you specify; “field updates” to update the value of a field on a record; and “outbound messages” to send a secure configurable API message (in XML format) to a designated listener. In other implementations, workflow rules 625 can also include a case counter with its description and its status.

In some implementations, approval processes 635 can specify the steps necessary for a record to be approved and who must approve it at each step. A step can apply to all records included in the process, or just records that have certain attributes. It can specify the actions to take when a record is approved, rejected, recalled, or first submitted for approval. In other implementations, approval processes 635 can include compliance review and content scanner with their respective description, status and process order information.

In some implementations, triggers 645 can act as scripts that execute before or after specific data manipulation language (DML) events occur, such as before object records are inserted into the database, or after records have been deleted. In other implementations, triggers 645 can also specify the API version used by the entity shape 603.

Users can select one or more methods described above across user interface 602, which is responsive to a user selection. In some implementations, users can create an entity shape 118 by selecting the appropriate check box associated with different methods like check box 614 associated with e-mail message type. The check boxes can be presented as widgets across the user interface 602. In other implementations, users can define values for various field in the different methods described above such as fields 603 and 604 of message standard fields 605.

### Custom Entity Shape Abstraction

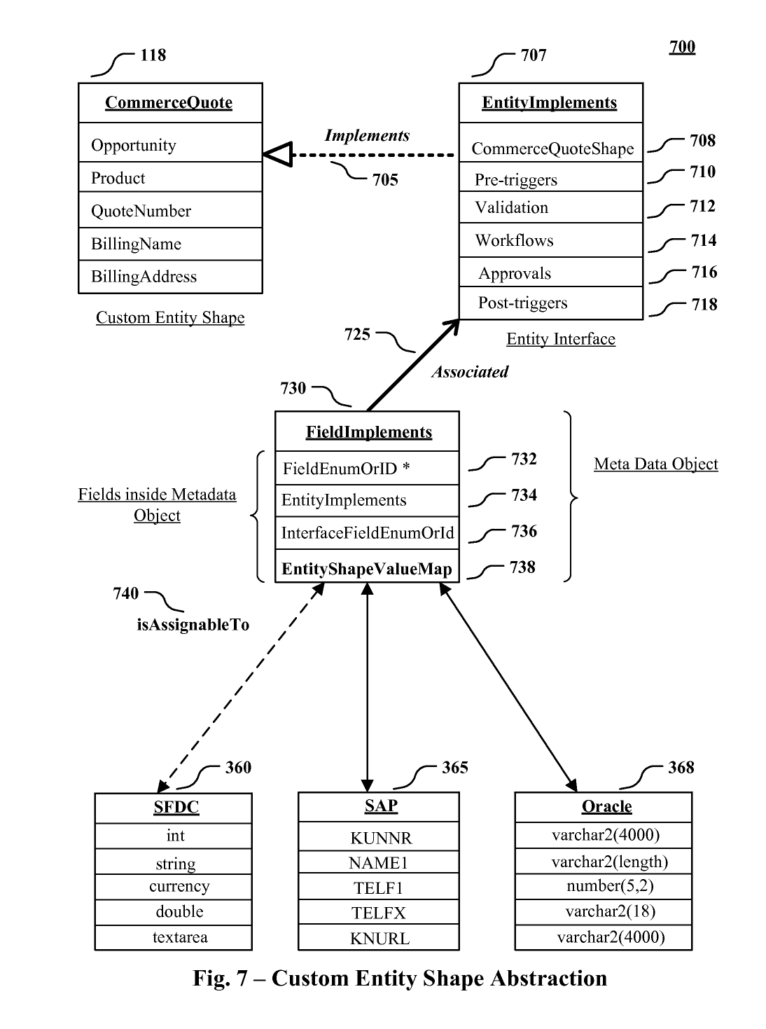

FIG. 7 is a block diagram of one implementation 700 of a custom entity shape abstraction. Other implementations may perform the steps in different orders and/or with different or additional steps than the ones illustrated in FIG. 7. For convenience, this diagram is described with reference to the system that carries out a method. The system is not necessarily part of the method, in one implementation.

In some implementations, Commerce Quote 118 can be defined using one or more fields such as Opportunity, Product, QuoteNumber, BillingName, BillingAddress, etc. Commerce Quote 118 can receive first user definitions of Opportunity, Product, QuoteNumber, BillingName, BillingAddress that connect the metadata objects and the fields of the metadata objects with the fields of the different data sources like SFDC 360, SAP 365 and Oracle 368. These first user definitions can be stored in Commerce Quote 118 and exposed to reuse by second and subsequent users, who can invoke the first user definitions that connect the Commerce Quote 118 with the different data sources. An example code for Commerce Quote 118 follows:

```
<entityInterface name=“CommerceQuote” owner=“stamm”
access=“orgHasCommerce”>
<field name=“Opportunity” fieldType=“FOREIGNKEY”
domain=“Opportunity” aggregateRelationshipName=“CommerceQuotes”
optional=“true”>
      <field name=“Name” dataType=“TEXT” >
      <field name=“BillingName” dataType=“TEXT”>
      <field name=“BillingAddress” fieldType=“ADDRESS”>
</entityInterface>
<entityInterface name=“CommerceQuoteItem” owner=“stamm”>
      <field name=“Parent” fieldType=“FOREIGNKEY”
      domain=“CommerceQuote”
      aggregateRelationshipName=“QuoteItems”/>
      <field name=“Product” fieldType=“FOREIGNKEY”
      domain=“Product2” optional=“true”/>
</entityInterface>
```

In the code above, a data entity interface named “CommerceQuote” is assigned “Opportunity” field as its foreign key, which is the primary key in the domain “Opportunity.” CommerceQuote includes multiple fields such as “Name” and “BillingName” with “TEXT” data type and “BillingAddress” with “ADDRESS” data type. Similarly, another data entity interface named “CommerceQuote” includes two foreign keys named “Parent” and “Product” in the respective “CommerceQuote” and “Product2” domains.

In some implementations, Commerce Quote 118 can be implemented by an entity 707 referred to as “EntityImplements” through an “implements” relationship 705 that includes one or more methods like CommerceQuoteShape 708, Pre-triggers 710, Validation 712, Workflows 714, Approvals 716, and Post-triggers 718, etc. An example code for EntityImplements 707 follows:

```
<setupEntity name=“EntityImplements” keyPrefix=“0CI” owner=“stamm”
  orgAccess=“always” genView=“true”
  javaPackageRoot=“core.entityinterface”
      apiAccess=“isDevInternal”
      editAccess=“UserPermissions.CustomizeApplication;
      isSFDCAdmin;isDelegatedAdmin”>
      <setupField name=“EntityEnumOrId” slot=“0”
      fieldType=“ENUMORID” domain=“CustomEntityDefinition”
      enum=“SchemaBuilderLayoutableEntities”
      dbValueRequired=“true” isApiUpdateable=“false”
      foreignKeyConstraint=“Cascade”/>
      <setupField name=“InterfaceEnumOrId” slot=“1”
      fieldType=“ENUMORID” isApiUpdateable=“false”
      domain=“CustomEntityDefinition”
      enum=“InterfaceEntities” dbValueRequired=“true”
      foreignKeyConstraint=“Cascade”/>
      <setupField name=“IsDefault” slot=“2”
      columnType=“BOOLEAN”/>
      <setupField name=“UniqueConstraint” columnType=“TEXT”
      formula=“InterfaceEnumOrId &amp; IF(isDefault,”,Id)”
      canBeCustomIndexed=“true” maxLength=“30”
      apiDescribeVisible=“false”
      comment=“Ensure that each interface has only one default
      implementation.”/>
      <flexIndex indexNum=“−1” field1Name=“EntityEnumOrId”
      field2Name=“InterfaceEnumOrId” caseSensitive=“true”
      unique=“true”/>
      <flexIndex indexNum=“−2” field1Name=“InterfaceEnumOrId”
      field2Name=“IsDefault”/>
      <flexIndex indexNum=“−3” field1Name=“UniqueConstraint”
      caseSensitive=“true” unique=“true”/>
<setupEntity>
```

In the code above, EntityImplements 707, assigned to the field “setupEntity name,” is associated with another entity 708 referred to as “FieldImplements” through an “associates” relationship 725. The “setupField name” field is assigned an ID referred to as “InterfaceEnumOrID”, which references the FieldImplements. The filed named “orgAccess” can be an organization-level access expression that is evaluated be accessible by a user-specified organization. The “javaPackageRoot” field refers to the java package that stores various entity objects, functions and test functions.

FieldImplements 708 can include user definitions that connect the metadata objects and the fields of the metadata objects with the fields of at least one of the data sources by mapping Commerce Quote 118 with another data source such as SAP 365 and Oracle 368 through an “is AssignableTo” relationship 740. In other implementations, FieldImplements 708 can also map Commerce Quote 118 with a multi-tenant data source like SFDC 360.

FieldImplements 730 implements the Commerce Quote 118 by connecting fields of Commerce Quote 118 to the fields 742 different data sources like SFDC 360, SAP 365 and Oracle 368. FieldImplements 708 can define one or more fields such as: FieldEnumOrID 732, which specifies the FieldImplements entity; EntityImplements 734, which specifies the associated EntityImplements; InterfaceFieldEnumOrID 736, which specifies the entity interface implemented by the associated EntityImplements; and EntityShapeValueMap 738, which specifies the different data sources. An example of FieldImplements 730 follows:

```
<setupEntity name=“FieldImplements” keyPrefix=“0CJ” owner=“stamm”
  orgAccess=“always” genView=“true”
  javaPackageRoot=“core.entityinterface”
      apiAccess=“isDevInternal”
      editAccess=“UserPermissions.CustomizeApplication;
      isSFDCAdmin;isDelegatedAdmin”>
      <setupField name=“EntityImplements” slot=“0”
      fieldType=“MASTERDETAIL” domain=“EntityImplements”/>
      <setupField name=“FieldEnumOrId” slot=“1”
      fieldType=“ENUMORID” domain=“CustomFieldDefinition”
      enum=“AllIndexableFields” dbValueRequired=“true”
      foreignKeyConstraint=“Restrict”/>
      <setupField name=“InterfaceFieldEnumOrId” slot=“2”
      fieldType=“ENUMORID” domain=“CustomFieldDefinition”
      enum=“AllInterfaceFields” dbValueRequired=“true”
      foreignKeyConstraint=“Restrict”/>
      <flexIndex indexNum=“−1” field1Name=“FieldEnumOrId”
      field2Name=“EntityImplements” caseSensitive=“true”
      unique=“true”/>
      <flexIndex indexNum=“−2”
      field1Name=“InterfaceFieldEnumOrId”
      field2Name=“EntityImplements” caseSensitive=“true”
      unique=“true”/>
      </setupEntity>
      <setupEntity name=“EntityShapeValueMap”/>
</setupEntity>
```

### Platform Entity Implementation

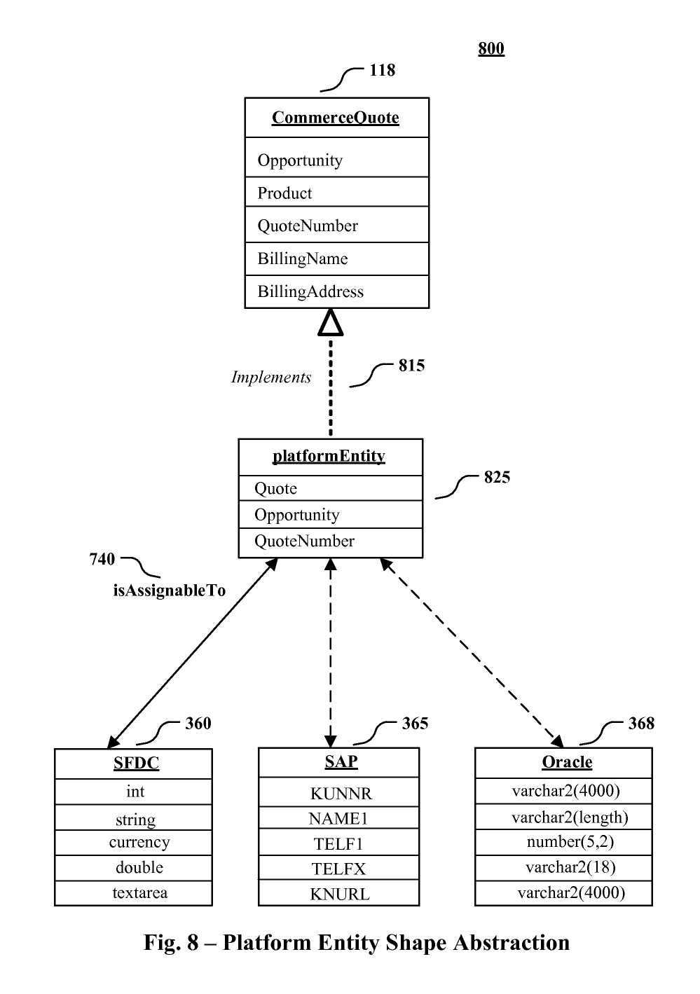

FIG. 8 is a block diagram of one implementation 800 of a platform entity. Other implementations may perform the steps in different orders and/or with different or additional steps than the ones illustrated in FIG. 8. For convenience, this diagram is described with reference to the system that carries out a method. The system is not necessarily part of the method.

Commerce Quote 118 can be implemented by another entity 825 referred to as “platformEntity” through an “implements” relationship 815. Commerce Quote 118 can create instances of a platform entity 825. Platform entity 825 can expose the standard data objects that can be accessed by users without requiring the users to supply user definitions that connect the platform entity 825 to standard data objects in the multi-tenant data source.

In some implementations, EntityImplements 707 and platformEntity 825 can alternative connections across the different data sources with a consistent interface behavior. An example code for platformEntity 825 follows:

```
<platformEntity name=“Quote” implements=“CommerceQuote”>
        <flexField name=“Opportunity”
        implements=“CommerceQuote.Opportunity”/>
        <flexField name=“QuoteNumber”
        implements=“CommerceQuote.Name”/>
</platformEntity>
```

### Integration Message Sequence Chart

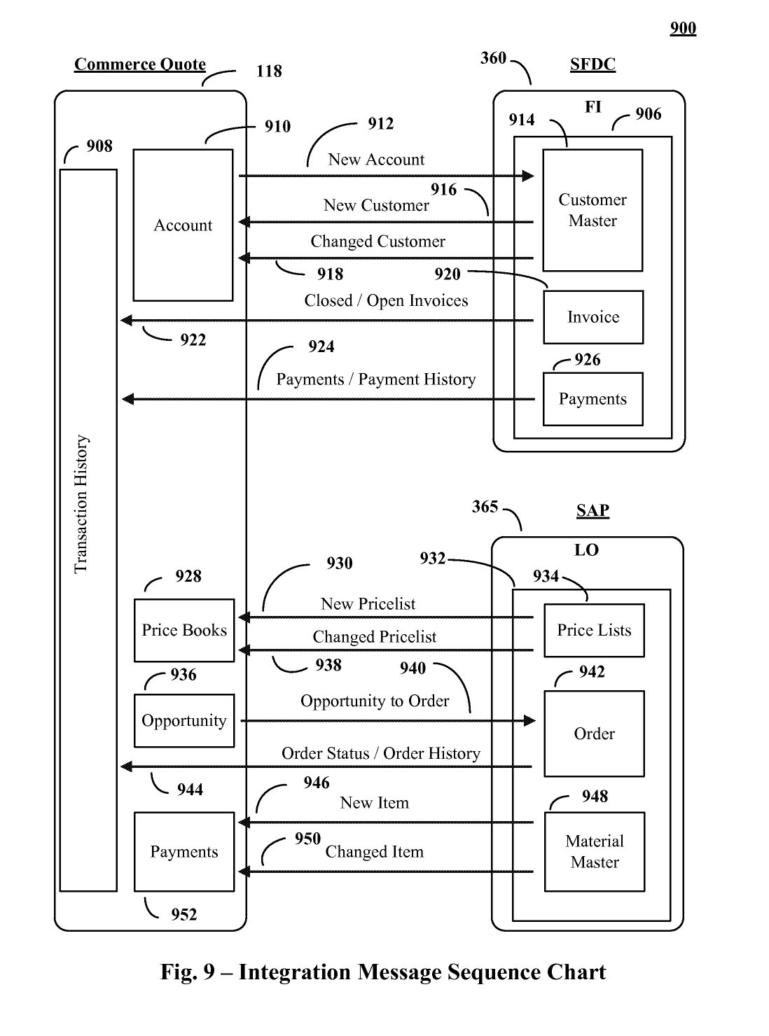

FIG. 9 is a message sequence chart of one implementation 900 for integrating an application including multiple entity interfaces with a multi-tenant data source such as SFDC 360 and another data source like SAP 365. Other implementations may perform the exchanges in different orders and/or with different or additional exchanges than the ones illustrated in FIG. 9. For convenience, this message sequence chart is described with reference to the system that carries out a method. The system is not necessarily part of the method. FIG. 9 illustrates a non-exhaustive list of information flows that support end-to-end CRM processes, such as opportunity-to-order, order-to-cash, and procure-to-pay.

As FIG. 9 illustrates, Commerce Quote 118 can provide access to one or more entity interfaces such as transaction history 908, account 910, price books 928, opportunity 936, and payments 952. SFDC 360 can include a database like financial accounting (FI) 906 with data tables such as customer master 914, invoice 920 and payments 928. Similarly, SAP 368 can include a database like logistics (LO) 932 with data tables like price lists 934, order 942 and material master 948.

Data flow between the application 118 and data sources 360 and 365 can be bi-directional, in one implementation. As described above in this application, Commerce Quote 118 can interact with a multi-tenant data base like SFDC 360. When a new account is created in account database 910 at exchange 912, a new customer can be added automatically to the customer-master data in SFDC 360, or a new customer in SFDC 360 can automatically add a new account-to-account database 910 at exchange 916. As updates are made to customer records on either side, the changes can be synchronized at exchange 918. Invoice or order history, as well as payment 926 and credit information from SFDC 360 can be made available in transaction history database 908 either in real time or in batch mode exchanges 922 and 924.

Commerce Quote 118 can also exchange data with another non-multitenant database base like SAP 360. SAP can include a database 932 such as LO with data structures 934, 942 and 948 that can be implemented as data tables or databases. New pricelists can be created in price books database 928 at exchange 930 and changes to the pricelists in pricelists table 934 at SAP 368 may then be synchronized back to price books database 928 at exchange 938. New opportunity-to-orders can be created in order table 942 at SAP 368 at exchange 940 with the assistance of available-to-promise checks and transferred to transaction history database 908 for fulfillment at exchange 944. In other implementations, new items can be created in payments database 952 at exchange 946 and changes to the items in material master table 948 at SAP 368 may then be synchronized back to payments database 952 at exchange 950.

### Entity Shape Abstraction Flow Chart

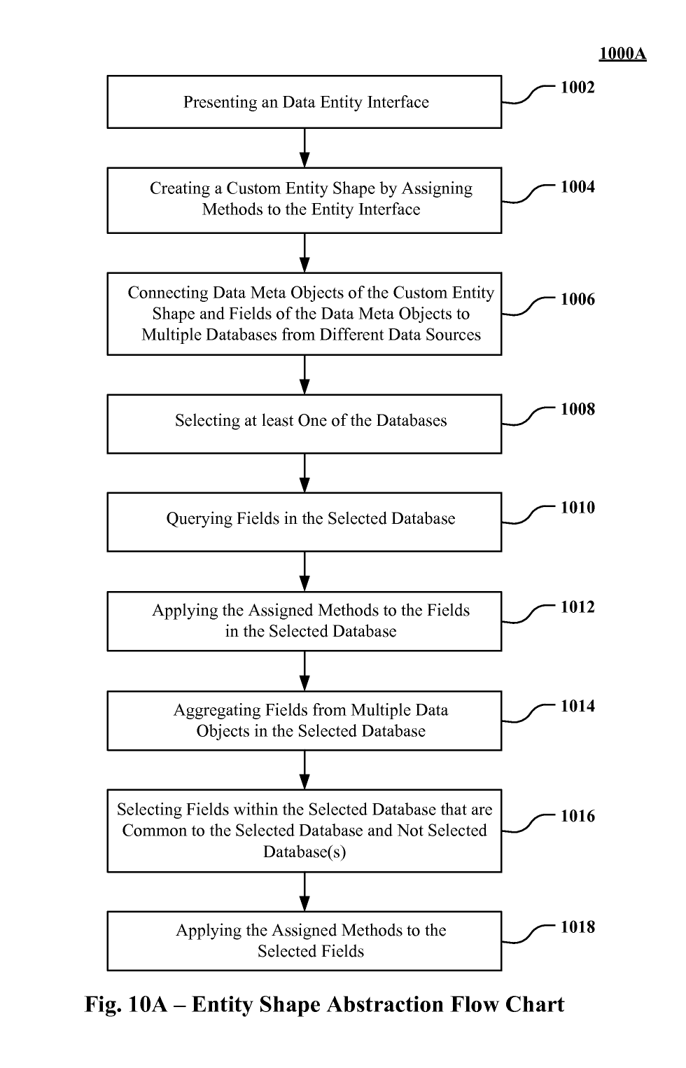

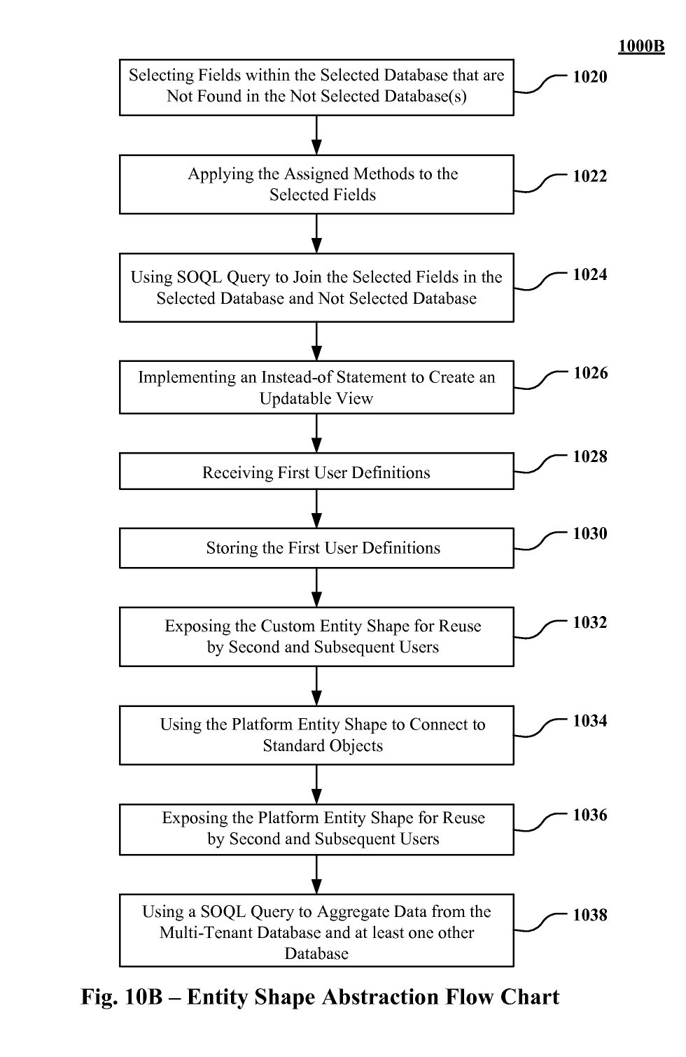

FIGS. 10A and 10B are high level flow-charts 1000A and 1000B of an entity shape abstraction. Other implementations may have the same blocks in different orders and/or with different or additional blocks than the ones illustrated in FIG. 10. For convenience, this flow-chart is described with reference to the system that carries out a method. The system is not necessarily part of the method.

At block 1002, a data entity interface is presented that connects multi-tenant database code to multiple databases from different data sources as described in FIGS. 3-4, 7-8. The entity interface serves as a common interface from a multi-tenant database application code to multiple databases from different data sources that have fields implementing at least some common data with different data structures. The entity interface is generated based on metadata objects having fields that connect to the multiple databases from different data sources.

A custom entity shape is created at block 1004 by assigning workflow rules, triggers, approval processes and other methods to the data entity interface. As described in FIG. 6, the custom entity shape serves as a common interface from a multi-tenant database code to multiple databases that have fields implementing at least some common data.

At block 1006, the metadata objects of the custom entity shape and fields of the metadata objects are connected via data abstractions to the multiple databases from different data sources. As described in FIG. 7, the data abstractions provide a consistent interface behavior across the databases irrespective of which of the multiple databases is accessed.

Workflow rules, triggers, approval processes and other methods described in FIG. 6 are assigned to the fields of the metadata objects at block 1008, which are responsive to a selection of at least one of the databases.

As described in FIG. 3, custom entity shape uses a processor at block 1010 to query fields in the selected database by automatically adapting the connection through the custom entity shape.

Custom entity shape assigns workflow rules, triggers, approval processes and other methods to the selected database thorough the processor at block 1012.

At block 1014, at least one of the metadata objects of the custom entity shape aggregates data fields from multiple data objects in one of the other databases shown in FIGS. 3 and 4.

At block 1016, a selection is made of fields within the selected database that are common to the selected database and a second, not selected database described in FIG. 3.

The selected fields are queried and assigned workflow rules, triggers, approval processes and other methods at block 1018.

At block 1020, a selection is made of fields within the selected database that are not found in a second, not selected database shown in FIG. 3.

The selected fields are queried and assigned workflow rules, triggers, approval processes and other methods at block 1022.

At block 1024, the SOQL query described in FIG. 4 is used to join the selected fields in the selected database and the other fields in the second database without requiring specification of the databases involved in a select-join statement.

At block 1026, the instead-of statement described in FIGS. 2 and 4 is implemented to make an updatable view resulting from a join across the databases updatable.

As described in FIG. 7, first user definitions are received at block 1028 that connect the metadata objects and the fields of the metadata objects with the fields of at least one other database.

At block 1030, the first user definitions are stored in the custom entity shape.

As described in FIG. 7, the custom entity shape is exposed for reuse to second and subsequent users at block 1032, allowing them to invoke the first user definitions that connect to the selected database.

Platform entity can implement the custom entity shape at block 1034, which connects fields from the platform entity to the custom entity shape. As described in FIG. 8, the standard fields are exposed via the platform entity to access by users at block 1036 without requiring the users to supply user definitions that connect the platform entity to the standard fields in the custom entity shape. The platform entity and other implementations of the custom entity shape can provide alternative connections with a consistent interface behavior.

A unified SOQL query is used for aggregating data from the multi-tenant database and at least one other database at block 1038. As described in FIG. 4, the SOQL query automatically implements user-specified functions against different databases and maps data objects to multiple backing tables.

### Some Particular Implementations

In one implementation, a method is described for presenting a data entity interface that connects multi-tenant database code to multiple databases from different data sources. The method includes providing a custom entity shape stored in memory that serves as a common interface from a multi-tenant database application code to multiple databases from different data sources that have fields implementing at least some common data with different data structures. The custom entity shape is generated based on metadata objects having fields that connect to the multiple databases from different data sources, wherein the custom entity shape provides a consistent interface across the databases that have the different data structures, irrespective of which of the multiple databases is accessed.

The method further includes assigning triggers and other methods to the fields of the metadata objects. It includes using a processor, responsive to a selection of at least one of the databases, to automatically adapt the connection through the custom entity shape to query fields in the selected database and to apply the assigned methods to the fields of the selected database.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as host-based entity shape, third-party based entity shape, query implementation, and the like.

The method further includes at least one of the metadata objects of the custom entity shape aggregating data fields from multiple data objects in one of the other databases. It further includes selecting fields within the selected database that are common to the selected database and a second, not selected database. It further includes querying and assigning methods to the selected fields in the selected database and the processor automatically adapting the connection to the selected fields in the selected database while connecting other fields in the metadata objects to the second, not selected databases.

The method further includes the custom entity object supporting joins between the selected fields in the selected database and the other fields in the second database without requiring specification of the databases involved in a select-join statement. It further includes the processor automatically implementing an instead-of statement to make an updatable view resulting from a join across the databases updatable.

The method further includes selecting fields within the selected database that are not found in a second, not selected database. It further includes querying and assigning methods to the selected fields in the selected database and the processor automatically adapting the connection to the selected fields in the selected database while connecting other fields in the metadata objects to the second, not selected databases.

The method further includes receiving from a first user definitions that connect the metadata objects and the fields of the metadata objects with the fields of at least one other database, storing the first user definitions in the custom entity shape and exposing the custom entity shape to reuse by second and subsequent users, whereby the second and subsequent users can invoke the first user definitions that connect.

The method further includes providing a platform entity implementation of the custom entity shape that connects to one or more standard objects in a multi-tenant database system as an alternative to objects in the other database, and exposing the standard data objects via the platform entity implementation to access by users without requiring the users to supply user definitions that connect the platform entity implementation to the standard data objects in the multi-tenant database. It further includes the platform entity implementation and other instances of the custom entity shape providing alternative connections with a consistent interface behavior across the multi-tenant database and the other database.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In another implementation, a method is described for connecting multi-tenant database code to a multi-tenant database and at least one other database from a different data source. The method includes providing an entity shape with a common data entity interface that provides access to a multi-tenant database and at least one other database from different data sources via a consistent run-time interface implementation regardless of the database and data source accessed, wherein the entity shape is a customizable abstract interface that automatically adopts user-selected workflow rules, approval processes and triggers to the databases. It further includes responding to a selection among the databases by connecting the common entity interface to the selected database and using a processor to automatically apply the user-selected workflow rules, approval processes and triggers to the selected database.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features.

The method further includes selecting fields within the selected database that are common to the selected database and a second, not selected database. It further includes querying and assigning methods to the selected fields in the selected database and the processor automatically adapting the connection to the selected fields in the selected database while connecting other fields in the metadata objects to the second, not selected databases.

The method further includes selecting fields within the selected database that are not found in a second, not selected database. It further includes querying and assigning methods to the selected fields in the selected database and the processor automatically adapting the connection to the selected fields in the selected database while connecting other fields in the metadata objects to the second, not selected databases.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In yet another implementation, a method is described for presenting a data entity interface that gathers data from a multi-tenant database and at least one other database. The method includes creating an entity shape that responds to a query by connecting metadata objects having fields to a multi-tenant database and to one or more other databases, wherein at least some of the metadata data objects gather fields from multiple foreign metadata objects in at least one of the other databases, wherein the entity shape assigns methods to the metadata data objects and fields.

The method further includes responding to a query that gathers data from the multi-tenant database and at least one other database, including the multiple foreign metadata objects, automatically connecting to the databases and applying the assigned methods.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In yet another implementation, a method of writing code agnostic to whether it runs against multi-tenant database or another database is described. The method includes defining a custom entity shape that connects multi-tenant database code to the multi-tenant database and alternatively connects the code to another database mapping database fields to custom entity shape fields invoking the multi-tenant database code with the custom entity shape pointed to the other database instead of the multi-tenant database. It is further enhanced by including with the custom entity shape triggers and other functions, automatically implementing the functions against the another database and by mapping objects to multiple backing tables.

1. A method for presenting a data entity interface that connects multi-tenant database code to multiple databases from different data sources, the method including:
providing a custom entity shape stored in memory that
serves as a common interface from a multi-tenant database application code to multiple databases from different data sources that have fields implementing at least some common data with different data structures;
is generated based on metadata objects having fields that connect to the multiple databases from different data sources, wherein the custom entity shape provides a consistent interface across the databases that have the different data structures, irrespective of which of the multiple databases is accessed; and
assigns triggers from multitenant database code to the fields of the metadata objects; and
responsive to a selection of a particular database source, using the custom entity shape to configure the connection automatically, including configuration of
access to fields in the selected database and
application of the assigned triggers to the selected database.

2. The method of claim 1, wherein at least one of the metadata objects of the custom entity shape aggregates data fields from multiple data objects in one of the other databases.

3. The method of claim 1, wherein:
a selection is made of fields within the selected database that are common to the selected database and a second, not selected database, querying and assigning methods to the selected fields in the selected database; and
the processor automatically adopts the connection to the selected fields in the selected database while connecting other fields in the metadata objects to the second, not selected databases.

4. The method of claim 3, further including the custom entity object supporting joins between the selected fields in the selected database and the other fields in the second database without requiring specification of the databases involved in a select-join statement.

5. The method of claim 4, further including the processor automatically implementing an instead-of statement to make an updatable view resulting from a join across the databases updatable.

6. The method of claim 1, wherein:
a selection is made of fields within the selected database that are not found in a second, not selected database, querying and assigning methods to the selected fields in the selected database; and
the processor automatically adopts the connection to the selected fields in the selected database while connecting other fields in the metadata objects to the second, not selected databases.

7. The method of claim 1, further including:
receiving from a first user definitions that connect the metadata objects and the fields of the metadata objects with the fields of at least one other database;
storing the first user definitions in the custom entity shape; and
exposing the custom entity shape to reuse by second and subsequent users, whereby the second and subsequent users can invoke the first user definitions that connect.

8. The method of claim 1, further including:
providing a platform entity implementation instance of the custom entity shape that connects to one or more standard objects in a multi-tenant database system as an alternative to objects in the other database; and
exposing the standard data objects via the platform entity implementation to access by users without requiring the users to supply user definitions that connect the platform entity implementation to the standard data objects in the multi-tenant database;
wherein the platform entity implementation and other instances of the custom entity shape provide alternative connections with a consistent interface behavior across the multi-tenant database and the other database.

9. A method for connecting multi-tenant database code to a multi-tenant database and at least one other database from a different data source, the method including:
providing an entity shape with a common data entity interface that provides access to a multi-tenant database and at least one other database from different data sources via a consistent run-time interface implementation regardless of the database and data source accessed;
wherein the entity shape is a customizable abstract interface that automatically adopts user-selected workflow rules, approval processes and triggers to the databases;
responding to a selection among the databases by connecting the common entity interface to the selected database; and
using a processor to automatically apply the user-selected workflow rules, approval processes and triggers to the selected database.

10. The method of claim 9, wherein:
a selection is made of fields within the selected database that are common to the selected database and a second, not selected database, querying and assigning methods to the selected fields in the selected database; and
the processor automatically adopts the connection to the selected fields in the selected database while connecting other fields in the metadata objects to the second, not selected databases.

11. The method of claim 9, wherein:
a selection is made of fields within the selected database that are not found in a second, not selected database, querying and assigning methods to the selected fields in the selected database; and
the processor automatically adopts the connection to the selected fields in the selected database while connecting other fields in the metadata objects to the second, not selected databases.

12. A computer system for presenting a data entity interface that connects multi-tenant database code to multiple databases from different data sources, the system including:
a processor and a computer readable storage medium storing computer instructions configured to cause the processor to:
providing a custom entity shape stored in memory that
serves as a common interface from a multi-tenant database application code to multiple databases from different data sources that have fields implementing at least some common data with different data structures;
is generated based on metadata objects having fields that connect to the multiple databases from different data sources, wherein the custom entity shape provides a consistent interface across the databases that have the different data structures, irrespective of which of the multiple databases is accessed; and
assigns triggers from multitenant database code to the fields of the metadata objects; and
responsive to a selection of a particular database source, using the custom entity shape to configure the connection automatically, including configuration of
access to fields in the selected database and
application of the assigned triggers to the selected database.

13. The system of claim 12, wherein at least one of the metadata objects of the custom entity shape aggregates data fields from multiple data objects in one of the other databases.

14. The system of claim 12, wherein:
a selection is made of fields within the selected database that are common to the selected database and a second, not selected database, querying and assigning methods to the selected fields in the selected database; and
the processor automatically adopts the connection to the selected fields in the selected database while connecting other fields in the metadata objects to the second, not selected databases.

15. The system of claim 14, further configured to cause the processor to support joins between the selected fields in the selected database and the other fields in the second database using the custom entity object without requiring specification of the databases involved in a select-join statement.

16. The system of claim 15, further configured to cause the processor to automatically implement an instead-of statement to make an updatable view resulting from a join across the databases updatable.

17. The system of claim 12, wherein:
a selection is made of fields within the selected database that are not found in a second, not selected database, querying and assigning methods to the selected fields in the selected database; and
the processor automatically adopts the connection to the selected fields in the selected database while connecting other fields in the metadata objects to the second, not selected databases.

18. The system of claim 12, further configured to cause the processor to:
receive from a first user definitions that connect the metadata objects and the fields of the metadata objects with the fields of at least one other database;
store the first user definitions in the custom entity shape; and
expose the custom entity shape to reuse by second and subsequent users, whereby the second and subsequent users can invoke the first user definitions that connect.

19. The system of claim 12, further configured to cause the processor to:
provide a platform entity implementation instance of the custom entity shape that connects to one or more standard objects in a multi-tenant database system as an alternative to objects in the other database; and
expose the standard data objects via the platform entity implementation to access by users without requiring the users to supply user definitions that connect the platform entity implementation to the standard data objects in the multi-tenant database;
wherein the platform entity implementation and other instances of the custom entity shape provide alternative connections with a consistent interface behavior across the multi-tenant database and the other database.

20. A computer system for connecting multi-tenant database code to a multi-tenant database and at least one other database from a different data source, the system including:
a processor and a computer readable storage medium storing computer instructions configured to cause the processor to:
provide an entity shape with a common data entity interface that provides access to a multi-tenant database and at least one other database from different data sources via a consistent run-time interface implementation regardless of the database and data source accessed;
wherein the entity shape is a customizable abstract interface that automatically adopts user-selected workflow rules, approval processes and triggers to the databases;
respond to a selection among the databases by connecting the common entity interface to the selected database; and
automatically apply the user-selected workflow rules, approval processes and triggers to the selected database.

21. The system of claim 20, wherein:
a selection is made of fields within the selected database that are common to the selected database and a second, not selected database, querying and assigning methods to the selected fields in the selected database; and
the processor automatically adopts the connection to the selected fields in the selected database while connecting other fields in the metadata objects to the second, not selected databases.
